(19) United States
(12) Patent Application Publication
(10) Pub. No.: US 2003/0065811 A1
(43) Pub. Date: Apr. 3, 2003

(54) Methods and apparatus for allocating working and protection bandwidth in a network

(76) Inventors: Philip J. Lin, Newton, MA (US); Timothy Y. Chow, Quincy, MA (US); James D. Mills, Wilmington, MA (US)

Correspondence Address: Kenneth J. Rudofski, Tellabs Operations, Inc., 1415 West Diehl Road, MS 16, Naperville, IL, 60563, US

(21) Appl. No.: 10/256,411

(22) Filed: Sep. 27, 2002

Related U.S. Application Data
(63) Continuation-in-part of application No. 10/146,212, filed on May 15, 2002.
(60) Provisional application No. 60/291,433, filed on May 16, 2001.

(51) Int. Cl. G06F 15/16; G06F 15/173

(52) U.S. Cl. 709/232; 709/238

(57) ABSTRACT

A method for protecting a mesh network from connection failures includes reviewing, for each link in the mesh network, the single failure scenarios which would require support from the particular link. The method includes determining from these single failure scenarios the worst-case bandwidth required of the particular link to support them and designating this worst-case bandwidth as the capacity for the particular link.

### RELATED APPLICATIONS

This patent application is a continuation-in-part of and claims priority to the co-pending non-provisional patent application having the assigned Ser. No. 10/146,212 filed on May 15, 2002, entitled “METHOD AND APPARATUS FOR ALLOCATING WORKING AND PROTECTION BANDWIDTH IN A TELECOMMUNICATIONS MESH NETWORK”, which claims priority to provisional patent application having the assigned serial No. 60/291,433 filed on May 16, 2001, entitled “METHOD AND APPARATUS FOR ALLOCATING WORKING AND PROTECTION BANDWIDTH IN A TELECOMMUNICATIONS MESH NETWORK”.

### FIELD OF THE INVENTION

The present invention relates to network protection. More specifically, the present invention relates to allocating protection bandwidth in a network such as an optical layer mesh network.

### BACKGROUND OF THE INVENTION

There exists a variety of methods of providing protection for a network in the case of a failure. Examples of such methods are synchronous optical network (SONET) protection rings such bi-directional line-switched rings (BLSR), uni-directional path-switched rings (UPSR). Other examples include protection schemes found in mesh networks, such as in an optical layer mesh.

Mesh protection schemes can be more flexible and bandwidth efficient that SONET ring protection methods. However, mesh protection schemes can be complicated and require complex optimization schemes in order to achieve bandwidth efficiency that one desires. Thus, there is a need for a simpler method to take advantage of what mesh networks can offer without complicated optimization algorithms.

### SUMMARY OF THE INVENTION

A method for protecting a mesh network from connection failures includes reviewing, for each link in the mesh network, the single failure scenarios which would require support from the particular link. The method includes determining from these single failure scenarios the worst-case bandwidth required of the particular link to support them and designating this worst-case bandwidth as the capacity for the particular link.

A method for migrating a mesh network with routes carrying active data and routes carrying copies of the active data from a dedicated 1+1 protection scheme to a shared protection scheme includes extinguishing any live traffic on each of the routes carrying copies of the active data, designating the routes carrying active data as working routes, and designating the routes carrying copies of the active data as protection routes. The method further includes reviewing for each link in the mesh network the single failure scenarios which would require support from the particular link, determining the worst-case bandwidth required of the particular link to support them, and designating this worst-case bandwidth as the capacity for the particular link.

A method for protecting a mesh network from connection failures when a connection is added to the mesh network includes determining in the mesh network a designated working route and a designated protection route to support the connection, and reviewing for each link in the designated working and protection routes the single failure scenarios along the designated working route which would require support from the particular link. The method includes determining from these single failure scenarios the worst-case bandwidth required of the particular link to support them, and designating this worst-case bandwidth as the capacity for the particular link.

### DESCRIPTION OF THE DRAWINGS

The present invention is illustrated by way of example and not by way of limitation in the figures of the accompanying drawings, in which like references indicate similar elements and in which:

FIG. 1 illustrates a portion of a mesh network that includes examples of pairs of link-disjoint paths, according to an exemplary embodiment of the present invention.

FIG. 2 illustrates a portion of a mesh network that includes examples of pairs of node-disjoint paths, according to an exemplary embodiment of the present invention.

FIG. 3 illustrates a flow diagram for allocating protection bandwidth in a mesh network, according to an exemplary embodiment of the present invention.

FIG. 4 illustrates the portion of a mesh network of FIG. 2 with exemplary faults.

FIG. 5 illustrates the portion of a mesh network of FIG. 1 with exemplary faults.

FIG. 6 illustrates a flow diagram for allocating protection bandwidth in a mesh network when a new connection is added to the mesh network, according to an exemplary embodiment of the present invention.

### DETAILED DESCRIPTION

Exemplary Embodiment Types of Networks

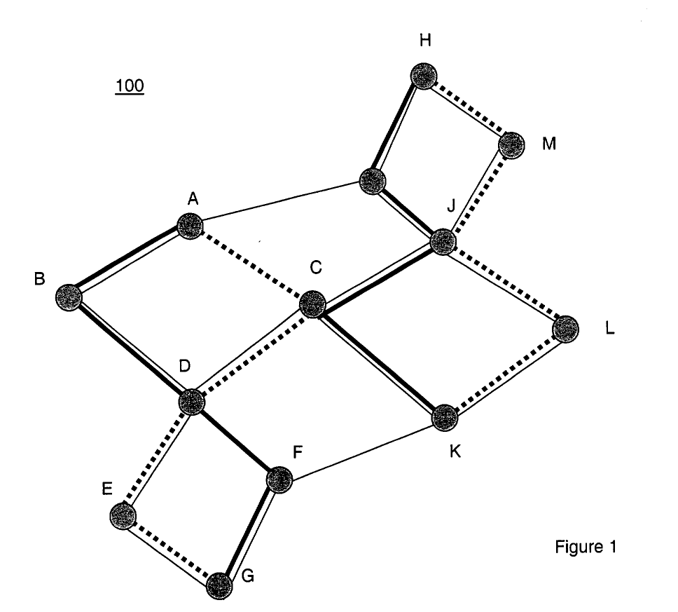

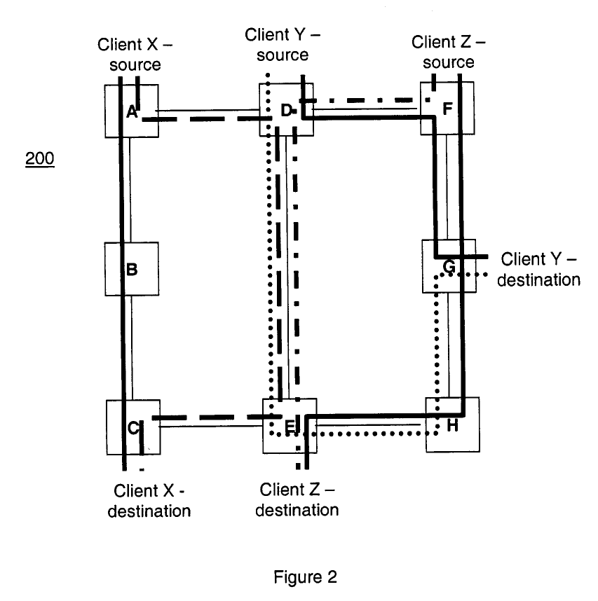

The protection scheme in the present invention can be implemented in a mesh network, for example a 2-connected network, a 3-connected network, or a multiply-connected network. In exemplary embodiments of the present invention, the mesh networks include pairs of disjoint paths. When paths are disjoint, the paths share a common source node and a common destination node. FIGS. 1 and 2 illustrate examples of pairs of disjoint paths. For example, FIG. 1 illustrates a portion of a mesh network 100 that includes nodes A, B, C, D, E, F, G, H, I, J, K, L and M and links AB, AC, AI, BD, CD, CJ, CK, DE, DF, EG, FG, FK, HI, HM, IJ, JM, JL and LK (indicated by thin solid lines). Between any two nodes in FIG. 1 are one or more disjoint pairs of paths. For example in FIG. 1, a possible disjoint pair of paths between nodes A and G is: ABDFG and ACDEG. When two paths are disjoint, the paths share a common source node and a common destination node. For example, paths ABDFG and ACDEG can share a common source node A and a common destination node G. Alternatively, paths ABDFG and ACDEG can share a common source node G and a common destination node A.

Disjoint paths may be either node-disjoint or link-disjoint. When two paths are link-disjoint, the paths share a common source node and a common destination node, but do not share intermediate links. FIG. 1 further illustrates examples of disjoint paths that are also link-disjoint. In FIG. 1, the paths ABDFG and ACDEG are link-disjoint. The paths can share a common source node A, a common destination node G and intermediate node D, but do not share any intermediate links.

Node-disjoint paths are link-disjoint paths with the additional requirement that no intermediate nodes can be the same. Thus, when two paths are node-disjoint, the paths share only a common source node and a common destination and no intermediate nodes or intermediate links. Furthermore, node-disjoint implies link-disjoint, but not vice versa. FIG. 2 illustrates examples of pairs of disjoint paths that are also node-disjoint. FIG. 2 illustrates a portion of a mesh network 200 that includes nodes A, B, C, D, E, F, G and H and links AB, BC, CE, AD, DE, EH, DF, FG and GH (indicated by thin solid lines). In FIG. 2, an exemplary pair of node-disjoint paths is ABC and ADEC, that share a common source node A and a common destination node C but do not share any intermediate nodes or intermediate links.

Developing a Protection Scheme

When given a network of nodes and links between nodes and a set of traffic demands consisting of connections between source nodes and destination nodes, a network designer can set up the connections such that the connections are protected against failures of interest. For example, a typical protection scheme can consist of designating a working route and a protection route for each connection (and upon a failure along the working route, a failed connection is re-routed onto the pre-determined protection route), allocating the capacity required for each link in the network, and selecting a signaling protocol that performs the protection. Typical protection schemes determine optimal working and protection routes and capacity in one step. As such, these schemes require complex optimization methods such as integer linear programming.

An exemplary embodiment of the present invention reduces the complexity of a protection scheme by separating the routing step from the capacity assignment step. A benefit of the two-step process is that it enables migration from a 1+1 dedicated protection scheme to a shared protection scheme. Another benefit is that it enables accommodation of traffic dynamics.

Selecting the Level of Protection in a Protection Scheme Through Path Utilization

An exemplary embodiment of the present invention designates a pair of disjoint paths between each source and destination node pair. Any pair finding algorithm may be employed to determine the disjoint paths. For instance, exemplary embodiments may use a shortest pair algorithm or a jointly shortest pair algorithm, as discussed in J. W. Suurballe and R. E. Tarjan, “A quick method for finding shortest pairs of disjoint paths”, Networks, Vol. 14 (1984), 325-336.

The protection level of a network can be determined by the types of paths chosen. For example, to protect against link failures, working and protection routes must be link disjoint. Further, to protect against node failures, working and protection routes must also be node-disjoint in addition to being link-disjoint.

Partial network 100 in FIG. 1 illustrates the protection level provided by link-disjoint paths. FIG. 1 shows an example of a pair of link-disjoint paths: working route ABDFG (indicated by thick solid lines) and protection route ACDEG (indicated by dashed lines). This arrangement protects against link failures, but not against node failures. For example, if traffic were running on working route ABDFG and link AB failed, the link failure could be protected by re-routing traffic on to protection route ABDEG. However, if traffic were running on working route ABDFG and intermediate node D failed, the node failure could not be protected. Traffic could not be re-routed to protection route ABDEG because protection route ABDEG includes failed intermediate node D.

Partial network 200 in FIG. 2 illustrates the protection level provided by node-disjoint paths. FIG. 2 shows an example pair of node-disjoint paths: working route ABC (indicated by thick solid lines) and protection route ADEC (indicated by dashed lines). This arrangement protects against node failures as well as link failures. For example, if traffic were running on working route ABC and link AB failed, the link failure could be protected by re-routing traffic on to protection route ADEC. Furthermore, if traffic were running on working route ABC and node B failed, the node failure could be protected by re-routing traffic on to protection route ADEC.

A variety of paths may be included in an exemplary embodiment mesh network. For example, paths that are node-disjoint, paths that are link-disjoint and paths that overlap one another may be used. Accordingly, an exemplary embodiment mesh network can employ an appropriate protection scheme. For example, a mesh network that includes link-disjoint paths can employ a link protection scheme and a mesh network that includes node-disjoint routes can employ node and link protection schemes.

Just as a variety of paths may be used in exemplary embodiments, links in the mesh network may be varied. For example, connections and links in the mesh network may be bi-directional, unidirectional or both. Thus, in exemplary embodiment partial networks in FIGS. 1 and 2, arbitrarily a node at one end of a connection is denoted as the “source” node and the node at the opposite end of the connection is denoted the “destination” node.

Further, links on a path may carry various combinations of working routes (indicated by thick solid lines in FIGS. 1 and 2) and protection routes (indicated by dashed lines in FIGS. 1 and 2). For example, in partial network 200 of FIG. 2, link DE carries three protection routes and link GH carries a working route and a protection route.

In an exemplary embodiment of the present invention, the protection scheme is shared rather than a dedicated protection scheme and thus a duplicate copy of the working traffic is not transmitted onto the protection route. Instead, protection bandwidth is allocated, but typically carries no traffic except when there is a failure. Thus, the protection bandwidth may be used for pre-emptable extra traffic.

A dedicated 1+1 protection scheme can be migrated to a shared protection scheme in an exemplary embodiment of the present invention. One of the simplest protection schemes being used today is a dedicated 1+1 protection scheme which sends for each connection active data on one route and a copy of the active data on another route. Of course, in this situation, protection bandwidth is not shared. However, an exemplary embodiment can easily migrate a dedicated 1+1 protection scheme to the shared protection scheme of the present invention by extinguishing the live traffic on the routes carrying the copies of active data, sharing the bandwidth on these routes and thus redeeming some of the capacity for future use.

When comparing the migration of a dedicated 1+1 protection scheme to the protection scheme of the present invention with the migration of a dedicated 1+1 protection scheme to a complex optimization protection scheme, the latter is more difficult to accomplish because in a complex optimization protection scheme, optimal routes and capacity are determined in one step. In the latter case, the working and protection routes will need to be changed according to fit the complex scheme. The former case is easier to accomplish because an exemplary embodiment of the present invention separates the routing step from the capacity assignment step, utilizes the same routes as established by the 1+1 scheme, and migrates the 1+1 scheme to a shared protection scheme via a simple reassignment of capacity.

Allocating Bandwidth in a Protection Scheme

Once the pairs of disjoint paths are determined, how much bandwidth to allocate on each link is determined. It is a simple calculation to determine the bandwidth required to support a working route; the bandwidth is simply the size of the connection. For example, if a link carries only working routes, the capacity needed is the sum of the working bandwidths. However, determining bandwidth on a link becomes complicated in the case for example where a link carries protection routes of traffic and the bandwidth on the protection routes is to be shared among several protection routes. Another complicated case of determining protection bandwidth is the case where a link carries both working and protection routes.

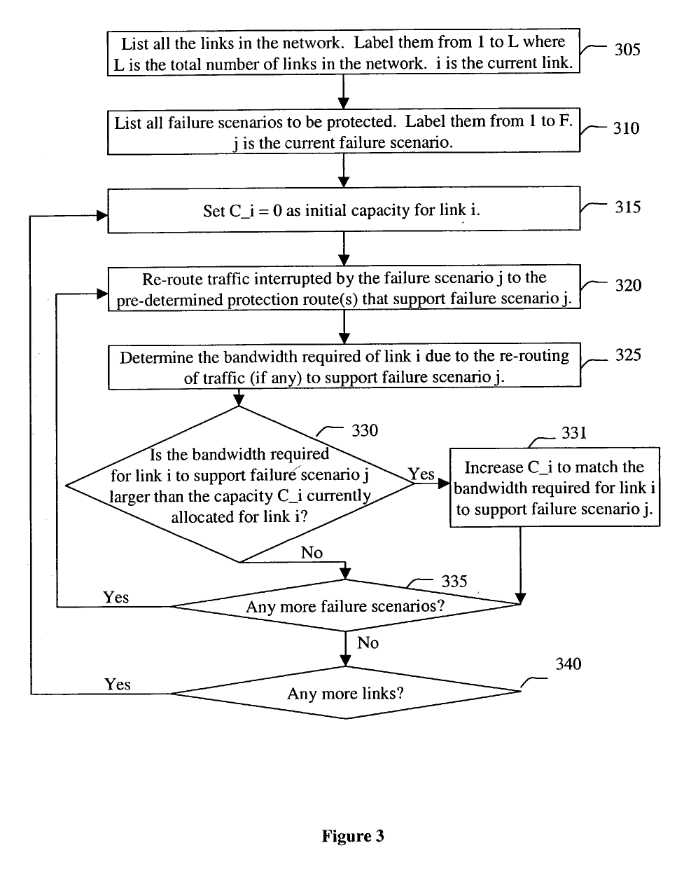

In an exemplary embodiment of the present invention, for a network including node-disjoint paths, for each link, the minimum amount of protection bandwidth that is required to recover from any single failure of a link or node is allocated. The precise amount of protection bandwidth to be allocated on a link can be determined as follows: for each link, simulate each failure of interest, determine the capacity needed for that link for each failure scenario, take the worst-case capacity as the capacity required for that link. FIG. 3 is a flow diagram that illustrates these steps in detail. At step 305, list all the links in the network. Label them 1 to L where L is the total number of links in the network. At step 310, list all failure scenarios to be protected. For example, to protect against all failures, list all link and node failure scenarios. To protect against link failures only, list only link failure scenarios. Label the failure scenarios from 1 to F. At step 315, for a link i in the network, set C_i=0 as the initial capacity for the particular link. For a failure scenario j, execute steps 320 through 330. At step 320, re-route the traffic interrupted by the failure scenario j to the pre-determined protection route(s) that support the failure scenario j. (Note that in the case of a node failure, traffic connections originate or terminate at the failed node are not re-routed.) At step 325, determine the bandwidth required of link i due to the re-routing of traffic (if any) to support the failure scenario j. At step 330, determine if the bandwidth required for the link is larger than the capacity C_i currently allocated for that link. If so, proceed to step 331 to increase the capacity of the link C_i to match the bandwidth required. Otherwise, proceed to step 335 to determine if there are any more failure scenarios. If there are any more failure scenarios, repeat steps 320 through 330 for each failure scenario 1 to F. If there are no more failure scenarios, repeat steps 315 through 335 for each link 1 to L.

The above steps will allocate the capacity required for each link in the network. The capacity allocated for a link is sufficient to handle the worst-case failure scenario for that link. Since each failure scenario can require from a link a protection bandwidth that is different than the protection bandwidth required from another link, the bandwidth of a link required to support a worst-case failure scenario is not necessarily the same for all links in the network.

Allocating Bandwidth to Protect Against Node and Link Failures

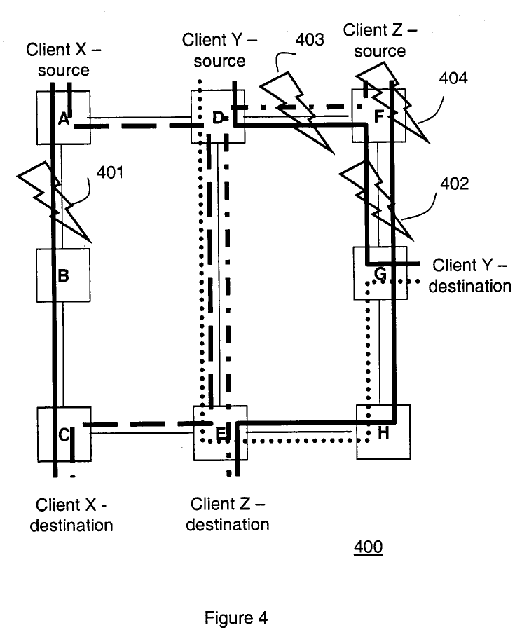

The exemplary embodiment in FIG. 4 protects against all single node and link failures. FIG. 4 shows the partial mesh network of FIG. 2 with exemplary faults. In FIG. 4, node-disjoint working routes (indicated by think solid lines) and protection routes (indicated by dashed lines) have been determined for each connection. Client X has a connection between nodes A and C with working route ABC and protection route ADEC. Client Y has a connection between nodes D and G with working route DFG and protection route DEHG. Client Z has a connection between node F and E with working route FGHE and protection route FDE.

In the exemplary embodiment in FIG. 4, the traffic demand consists of three connections of size one bandwidth unit each. For ease of explanation, the size of one bandwidth unit is used in this example. However, one ordinarily skilled in the art will recognize that the size of a connection can be more than one bandwidth unit and that a bandwidth unit may be for example a wavelength, time-slot in a wavelength or fiber.

For some links, determining bandwidth required on each link is a simple calculation. For example, link AB only carries Client X's working route, so the amount of bandwidth needed for link AB is simply one unit bandwidth. But, this is not obvious for links that are used by one or more protection routes.

To determine the bandwidth allocation for link DE, first review all failure scenarios (both link and node failures) and find the worst-case failure scenario that requires the most capacity. For example, if failure 401 (failure of Client X's working route at link AB) occurs, then only one of the three protection routes on link DE will be activated. Therefore, link DE bandwidth must be at least one bandwidth unit. However, this is not the worst-case failure scenario for link DE. The worst-case failure scenario is failure 402, the failure of Client Y and Client Z's working routes at link FG. For this worst-case, Client Y and Client Z's protection routes on link DE are activated. Therefore, the bandwidth required for link DE is two units. An advantage of this shared protection scheme of the present invention is that bandwidth is saved by sharing the protection bandwidth on link DE. In a dedicated protection scheme, three bandwidth units are required for link DE because dedicated capacity needs to be allocated to all of the protection routes even when they may not be used simultaneously.

As another illustration, to determine the bandwidth required on link GH, first review all failure scenarios (both link and node failures) and find the worst-case failure scenario that requires the most capacity. Link GH carries Client Z's working route and Client Y's protection route. Initially, GH only requires 1 unit of bandwidth to support Client Z's working route. Failure 401 (failure of link AB) does not increase the bandwidth requirements of link GH. Failure 402 (failure of link FG) disconnects Client Z and Client Y's working routes. Both of these clients will now re-route their connections through the pre-determined protection routes. This action requires link GH to still only need one unit of bandwidth because although failure 402 causes Client Y's protection route to be activated on link GH, Client Z's working route has disappeared (re-routed) due to the failure. However, failure 403 (failure of link DF) requires link GH to support both Client Z's working route and the Client Y's protection route simultaneously. This is the worst-case scenario for link GH. Therefore, the capacity required for link GH is two bandwidth units.

Some node failure cases will be similar to failure 404, a failure of a terminal for a demand. Specifically, it is a failure of the source node of Client Z's connection. That demand cannot be re-routed on the protection route because the protection route also originates at the source node of Client Z's connection. Therefore, when calculating bandwidth, care must be taken not to add the bandwidth required for rerouting failures at source nodes and destination nodes.

The methods described herein for determining bandwidth are applicable to networks that employ stub release as well as networks that do not employ stub release. In employing stub release, the capacity of an entire working route is released upon the failure of a working route. For example, in FIG. 4, failure 402 (failure of link FG) causes Client Z's working route FGHE to fail. What is left of Client Z's working route is a “stub” GHE. A network employing stub release will release the capacity of the stub GHE while a network not employing stub release will not release the capacity of the stub GHE. In networks that do not employ stub release, in determining bandwidth of a link to support a particular failure, additional bandwidth may need to be allocated for stubs. For example, in a network that does not employ stub release, the bandwidth required of link GH to support failure 402 is two bandwidth units because the failure causes Client Y's protection route to be activated on link GH and the stub GHE of Client Z's working route is not released. In a network that does employ stub release, the bandwidth required of link GH to support failure 402 is one bandwidth unit because the failure causes Client Y's protection route to be activated on link GH and the stub GHE of Client Z's working route is released.

Allocating Bandwidth to Protect Against Link Failures Only

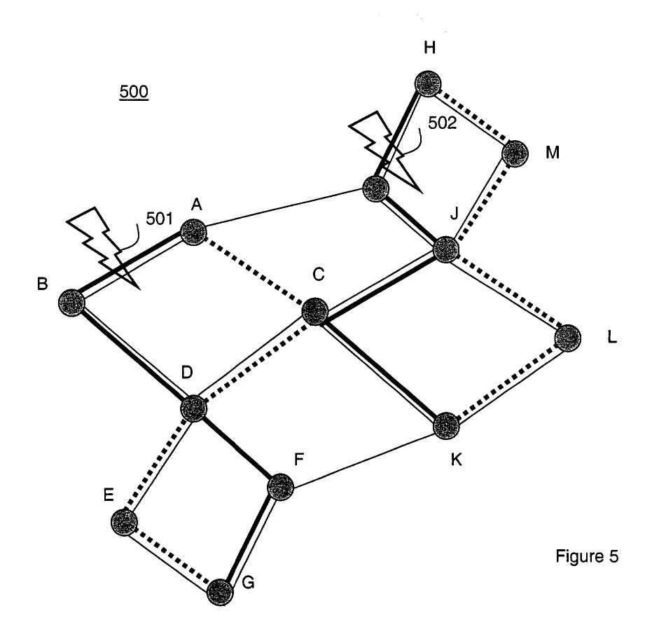

The method described above may be used on a network including link-disjoint pairs of paths, where protection is available for link failures. FIG. 5 illustrates the partial mesh network of FIG. 1 with exemplary faults. FIG. 5 also shows examples of link-disjoint pairs of paths. For example, the pair of link-disjoint paths ABDFG and ACDEG share common source node A, common destination node G and intermediate node D, but do not share any intermediate links. In this exemplary embodiment of the present invention, the minimum amount of bandwidth that is required to recover from any failure of a link is allocated. The precise amount of bandwidth to be allocated on a link is computed by first reviewing every failure scenario of a link, and computing how much protection bandwidth (if any) would be needed on the link to support each scenario. Then, bandwidth is allocated on that link to handle the worst-case failure scenario.

FIG. 5 may be used to illustrate determining bandwidth for a particular link. In this example, one pair of link-disjoint paths is path ABDFG (with links AB, BD, DF and FG) and path ACDEG (with links AC, CD, DE and EG), sharing a common source node A, a common destination node G, a common intermediate node D, but no common intermediate links. Another pair of link-disjoint paths is path HIJCK (with links HI, IJ, JC and CK) and path HMJLK (with links HM, MJ, JL and LK). The amount of protection bandwidth for link AC is determined by first reviewing for each link in the entire network, how much protection bandwidth on link AC is necessary to support a failure of that particular link. For example, if link AB supports three working bandwidth units and failure 501 (failure of link AB fails) occurs, three bandwidth units are needed on link AC to support that failure. However, if failure 502 (failure of link HI) occurs, protection bandwidth is not necessary on link AC to support that failure.

In an exemplary embodiment of the present invention, the total number of bandwidth units on each link of carrying a protection route is pre-computed. Traffic is not assigned to a link carrying a protection route until a failure occurs.

Allocating Bandwidth When a New Connection, Link, or Node is Added to or Deleted from the Network

One advantage of the present invention, when compared to a complex optimized protection scheme, is that the protection for the entire network does not have to be re-designed or re-optimized due to a simple change to the network such as the addition or subtraction of a traffic demand. In an exemplary embodiment of the present invention, if a new connection is required, a pair of link or node-disjoint paths (depending on the level of protection desired) would be assigned to support the new connection and the traffic would be routed accordingly. The capacity on the links on the working routes would be increased by an amount equal to the bandwidth of the connection. The capacity of the links on the protection routes may also be increased. Adjusting the bandwidth on links in the network to accommodate the new connection can be easily determined using the method of the present invention but reviewing only the failure scenarios along the working route of the new connection.

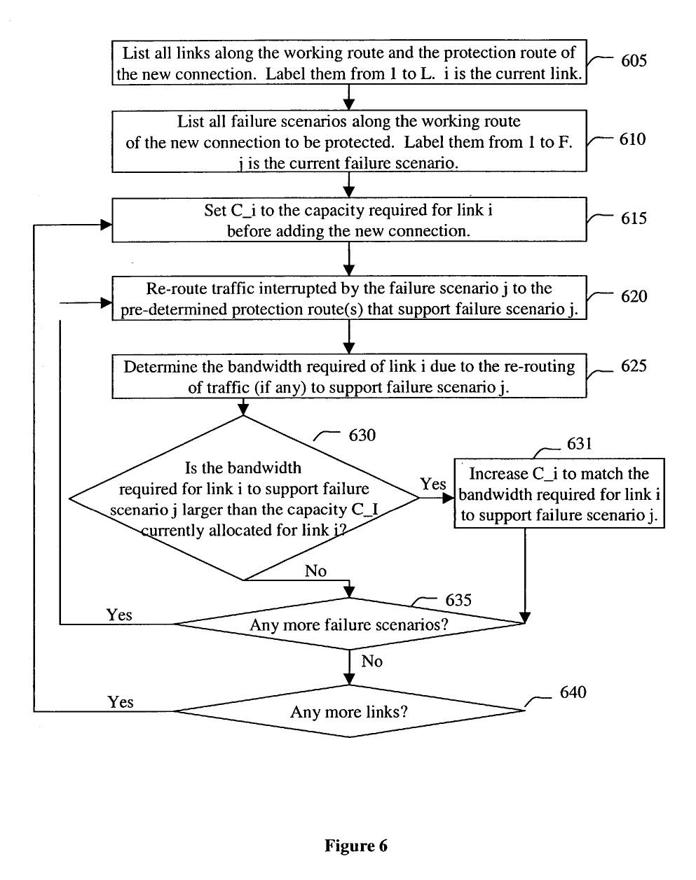

FIG. 6 is a flow diagram that illustrates how an exemplary embodiment accommodates a new connection. At step 605, list only the links along the working route and the protection route of the new connection. Label them 1 to L. At step 610, list only failure scenarios along the working route of the new connection to be protected. For example, to protect against all failures, list all link and node failure scenarios. To protect against link failures only, list only link failure scenarios. Label them 1 to F. At step 615, for a link i in the network, initially set C_i to the capacity required for the particular link before adding the new connection. For a failure scenario j, execute steps 620 through 630. At step 620, re-route the traffic interrupted by the failure to the pre-determined protection route(s) that support the failure scenario j. At step 625, determine the bandwidth required of link i due to the re-routing of traffic (if any) to support the failure scenario j. At step 630, determine if the bandwidth required for the link is larger than the capacity C_i currently allocated for that link. If so, proceed to step 631 to increase the capacity of the link C_i to match the bandwidth required. Otherwise, proceed to step 635 to determine if there are any more failure scenarios. If there are any more failure scenarios, repeat steps 620 through 630 for each failure scenario 1 to F. If there are no more failure scenarios, repeat steps 615 through 635 for each link 1 to L.

The above steps will allocate the capacity required for each link in the network after a new connection has been added. The capacity allocated for a link is sufficient to handle the worst-case failure scenario for that link.

Similarly, if a traffic connection is to be deleted, capacity in the network can be redeemed for future use. In this case, the same procedure discussed above is used. This time, the procedure is applied over only the links of the working and protection routes of the deleted connection and for each link, the procedure is applied for only the failure scenarios along the working route of the deleted connection.

Furthermore, if a node or link is added to the network, the working and protection routes of existing connections need not be changed. The same procedure discussed above can be used to add new connections as they arise with the network graph modified by the new node or link.

If a node or link is deleted from the network, first, all traffic utilizing the deleted node or link is removed from the network because the associated routing assignments are no longer valid. These traffic connections are removed one by one using the deletion procedure discussed above. The traffic connections are then added back on using the traffic connection addition procedure discussed above but on the new network graph without the deleted node or link.

In exemplary embodiments of the present invention, protection bandwidth allocation may be computed by for example a human being, a network management system, a control plane, or a computer.

Nodes in exemplary embodiments of the present invention may offer various features. For example, an exemplary embodiment is an optical network with wavelength conversion available at every node. Thus for example, a lightpath from a source to a destination may use different wavelengths on different links. An exemplary embodiment may use a transponder, semi-conductor amplifier, or other wavelength conversion devices, residing at a node to convert wavelengths. However in other exemplary embodiments of the present invention, wavelength conversion is not available at some or all nodes. Two consequences of the absence (or limited number) of wavelength conversion might be a slight increase the bandwidth requirement and an increase in the complexity of the network management

Another node feature that an exemplary embodiment of the present invention may have is time-slot interchange. For example, an exemplary embodiment may employ a time-division multiplexer residing at a node to assign a stream to a particular time-slot.

A problem that may occur in the case that multiple connections exist between the same pair of source-destination nodes, is that the links in the working route may be overloaded. This is because there is only one working/protection pair between the source and destination node. An embodiment of the present invention may solve this problem by providing multiple pairs of working/protection routes and distributing the load so as not to overwhelm any links.

Selecting a Signaling Protocol in a Protection Scheme

Embodiments of the present invention may perform signaling in many different ways. In one exemplary embodiment, upon the failure of a link or a node, the destination node detects the failure, by for example detecting loss of light or loss of signal, and transmits a notification upstream to the source node along the protection route. Upon receiving this message, the source node transmits an acknowledgment (Ack) downstream to the destination node along the protection route and switches the working traffic to the protection route. As each node on the protection route receives the Ack, from the source node to the destination node, it forwards the Ack, and chooses a bandwidth unit on the next link on the protection route to switch the traffic onto. When the destination receives the Ack and makes the appropriate switch, the protection is complete.

In an exemplary embodiment of the present invention, each frame or signal packet has as part of its overhead a unique connection identification (ID) as well as some bytes for transmitting signaling information. The connection ID distinguishes the connection from all other connections in the network, including connections that share the same source and destination nodes but travel on different transmission means (e.g. fibers, copper wires) and/or bandwidth units (e.g. wavelengths, time-slots, time-slots in a wavelength or fibers). If traffic is bi-directional, the two directions are given different connection ID's.

In an exemplary embodiment of the present invention, each node has two tables of information, a routing table and a unit table. A routing table of node may specify for example, for each connection ID whose protection route contains that particular node, the upstream and downstream links for that connection. A unit table of a node may specify for example, for each link that is incident to that particular node, a list of the fibers and wavelengths on each fiber available for routing protection traffic.

When there is a link failure or a node failure, the nodes downstream of the failure detect the failure, by for example detecting loss of signal or loss of light. Each of these downstream nodes will check to see if it is the destination node of the failed working route. If a node is not the destination node, the node will not take action (other than for example generating an AIS on the failed channel). If the node is the destination node, the node transmits a notification upstream to the source node along the corresponding protection route for that failed working route. Each node along the protection route uses its routing table to determine what the next hop should be.

When the source node receives the notification, it then transmits an acknowledgment back down the protection route, as well as switching the working traffic onto the protection route and generating for example an AIS on the working route. As each node on the protection route receives the acknowledgment, it uses its routing table to determine the next hop, and it uses its unit table to determine an available bandwidth unit on that next hop. The node switches the traffic onto that bandwidth unit, and the unit table is updated accordingly.

The unit table is necessary in the case where there is a second failure in a network; protection bandwidth units that are in use due to the first failure will not be pre-empted. Conversely, the unit tables allow failures after the first to be protected if there is sufficient residual protection bandwidth.

In an exemplary embodiment of the present invention, nodes on the protection route switch traffic to an available bandwidth unit until after the source node transmits an Ack. One might think that time is saved if the nodes on the protection route switch to a protection bandwidth unit during the upstream transmission of the failure notification from the destination node to the source node along the protection route. However if the failure is at the source node, then according to the provisioning rules described herein, such protection route nodes and links not entitled to any protection bandwidth. But when the destination node detects a failure, it does not know whether the failure occurred at the source node or at an intermediate node. Thus, if one were to reserve protection bandwidth units during the upstream transmission of the failure notification, one might lock up valuable protection bandwidth units and block legitimate requests for that protection bandwidth.

A single link or node failure may cause many end-to-end light paths to fail. Therefore, in an exemplary embodiment of the present invention, each light path generates its own failure signal. Thus in this exemplary embodiment, each node in the network is equipped with the ability to queue multiple signaling requests and process them in order.

Exemplary embodiments of the present invention use different ways to transmit signaling information such as for example: in-band signaling, out-of-band signaling, optical supervisory channels and pilot tones. An exemplary embodiment may use in-band signaling and OEO conversion at each node.

An exemplary embodiment of the present invention may use a variation on the above-described signaling scheme: the destination informs the source of a failure by flooding the network with signals, instead of transmitting the signal only up the corresponding protection route. This may speed up the first part of the signaling process. However, since each node already must queue multiple signals, flooding could overload these queues and cause greater overall delay.

In an exemplary embodiment of the present invention, the destination node is solely responsible for notifying other network elements of a failure. Therefore, if the destination node fails, the other nodes, including the source node, might continue to believe that the working route is healthy. To fix this problem, in an exemplary embodiment may, the destination node continually transmits to the source node health (e.g. keep-alive) signals.

In the foregoing description, the invention is described with reference to specific exemplary embodiments thereof. It will, however, be evident that various modifications and changes may be made thereto, without departing from the broader spirit and scope of the present invention. For example, some of the steps illustrated in the flow diagrams may be performed in an order other than that which is described. It should be appreciated that not all of the steps illustrated in the flow diagrams are required to be performed, that additional steps may be added, and that some of the steps may be substituted with other steps. The specification and drawings are accordingly to be regarded in an illustrative rather than in a restrictive sense.

What is claimed is:

1. A method of protecting a mesh network from connection failures, comprising:
determining for a link in the mesh network a worst-case bandwidth for the link to support single failure scenarios; and
designating the worst-case bandwidth as a capacity for the link.

2. The method of claim 1 further comprising determining working routes and protection routes in the mesh network.

3. The method of claim 1 wherein the mesh network is a multiply-connected network.

4. The method of claim 1 wherein the link carries bi-directional traffic.

5. The method of claim 2 wherein determining working routes and protection routes in the mesh network comprises using a jointly shortest pair algorithm.

6. The method of claim 2 further comprising designating a signaling protocol to assign traffic to one of the protection routes due to a failure of one of the working routes.

7. The method of claim 2 wherein each of the working routes is link-disjoint to one of the protection routes and the single failure scenarios comprise all single link failure scenarios.

8. The method of claim 2 wherein each of the working routes is node-disjoint to one of the protection routes and the single failure scenarios comprise all single link and single node failure scenarios.

9. The method of claim 2 further comprising employing stub release to release a bandwidth of one of the working routes due to a failure of the one of the working routes.

10. A method of migrating a mesh network with routes carrying active data and routes carrying copies of the active data from a dedicated 1+1 protection scheme to a shared protection scheme comprising:
extinguishing any live traffic on each of the routes carrying copies of the active data;
designating the routes carrying active data as working routes;
designating the routes carrying copies of the active data as protection routes;
determining for a link in the mesh network a worst-case bandwidth for the link to support single failure scenarios; and
designating the worst-case bandwidth as a capacity for the link.

11. The method of claim 10 further comprising designating a signaling protocol to assign traffic to one of the protection routes due to a failure of one of the working routes.

12. The method of claim 10 wherein each of the working routes is link-disjoint to one of the protection routes and the single failure scenarios comprise all single link failure scenarios.

13. The method of claim 10 wherein each of the working routes is node-disjoint to one of the protection route and the single failure scenarios comprise all single link and single node failure scenarios.

14. A method of protecting a mesh network with working routes and protection routes from connection failures when a connection, link, or node is added or deleted to the mesh network, comprising:
determining a designated working route and a designated protection route to support the connection;
reviewing for links in the designated working route and the designated protection route, single failure scenarios along the designated working route which would require support from each link;
determining for the each link a worst-case bandwidth to support the single failure scenarios; and
designating the worst-case bandwidth as a capacity for the each link.

15. The method of claim 14 wherein determining a designated working route and a designated protection route to support the connection comprises using a jointly shortest pair algorithm.

16. The method of claim 14 further comprising designating a signaling protocol to assign traffic to one of the protection routes due to a failure of one of the working routes.

17. The method of claim 14 wherein each of the working routes is link-disjoint to one of the protection routes and the single failure scenarios comprise all single link failure scenarios.

18. The method of claim 14 wherein each of the working routes is node-disjoint to one of the protection routes and the single failure scenarios comprise all single link and single node failure scenarios.

19. The method of claim 14 further comprising employing stub release to release a bandwidth of one of the working routes due to a failure of the one of the working routes.

20. The method of claim 14 wherein the links in the designated working route and the designated protection route are all of the links in the designated working route and the designated protection route.
